(19) United States
(12) Patent Application Publication
(10) Pub. No.: US 2010/0075722 A1
(43) Pub. Date: Mar. 25, 2010

(54) MOBILE COMMUNICATION SYSTEM AND CONTROLLING METHOD THEREOF

(75) Inventor: GUANG-YU PEI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO. LTD., Shenzhen City (CN); HON HAI PRECISION INDUSTRY CO., LTD., Tu-Cheng (TW)

(21) Appl. No.: 12/508,581

(22) Filed: Jul. 24, 2009

(30) Foreign Application Priority Data
Sep. 24, 2008 (CN) 200810304634.0

(51) Int. Cl. H04M 1/00

(52) U.S. Cl. 455/569.1

(57) ABSTRACT

A mobile communication system includes a headphone and a mobile communication terminal. The headphone includes a signal transceiver, an audio transducer, and a detection module. The signal transceiver is configured for communicating with the mobile communication terminal. The audio transducer is electrically connected to the signal transceiver and comprises a microphone and a speaker. The detection module is configured for detecting movements of the headphone to produce a plurality of detection signals accordingly. The mobile communication terminal includes a transceiver module and a communication module. The transceiver module is configured for communicating with the signal transceiver. The communication module is configured for answering/rejecting an incoming call or terminating an active communication according to the detection signals.

### BACKGROUND

1. Technical Field

The present disclosure relates to mobile communication technologies, and particularly, to a mobile communication system and a controlling method thereof.

2. Description of Related Art

Keypads or touch screens are frequently used for answering a call in a mobile communication terminal. Such keypads or touch screens require users to press the keypads or touch the touch screens directly by hands. However, this is inconvenient if the users are busy doing something with their hands, such as driving.

Therefore, what is needed is to provide a mobile communication system and a controlling method thereof, in which the limitations described above, are eliminated or alleviated.

### BRIEF DESCRIPTION OF THE DRAWINGS

FIG. 1 is a schematic view of a mobile communication system, according to a first exemplary embodiment.

FIG. 2 is a functional block diagram of the mobile communication system of FIG. 1.

FIG. 3 is a flowchart of a controlling method of the mobile communication system of FIG. 2.

FIG. 4 is a functional block diagram of a mobile communication system, according to a second exemplary embodiment.

FIG. 5 is a flowchart of a controlling method of the mobile communication system of FIG. 4.

### DETAILED DESCRIPTION

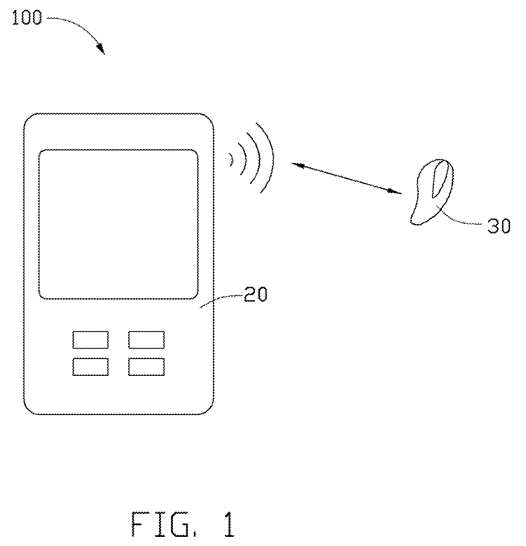

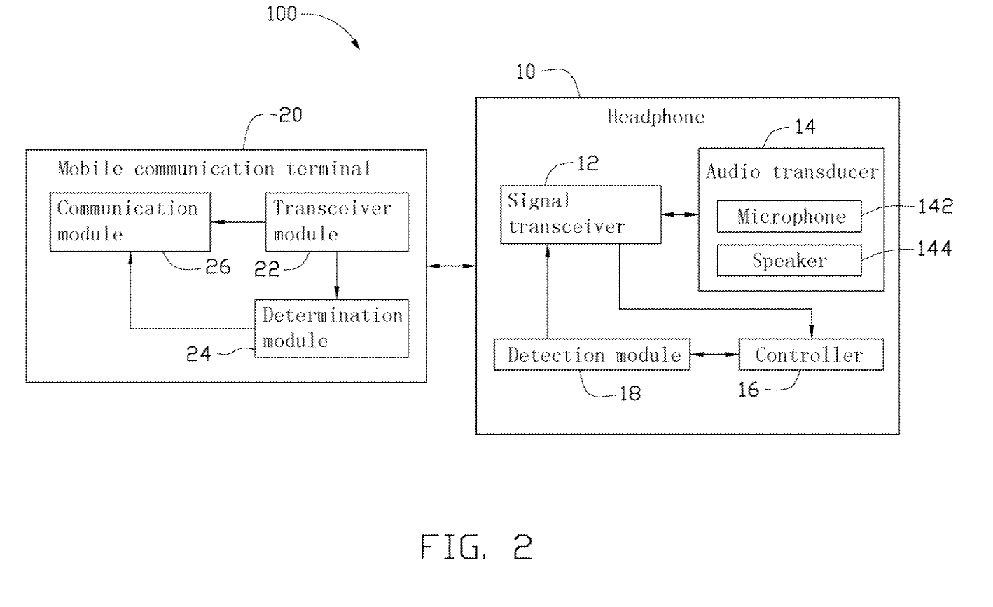

Referring to FIGS. 1 and 2, a mobile communication system 100, according to a first exemplary embodiment, includes a headphone 10 and a mobile communication terminal 20. The mobile communication terminal 20 may be a mobile phone, or a personal digital assistant (PDA). In this embodiment, the mobile communication terminal 20 is a mobile phone. The headphone 10 communicates with the mobile communication terminal 20 wirelessly, in this embodiment.

The headphone 10 includes a signal transceiver 12, an audio transducer 14, a controller 16, and a detection module 18.

The signal transceiver 12 is configured for communicating with the mobile communication terminal 20 wirelessly. The signal transceiver 12 may be a BLUETOOTH device.

The audio transducer 14 is electrically connected to the signal transceiver 12. The audio transducer 14 includes a microphone 142 and a speaker 144.

The controller 16 is configured for controlling the detection module 18, e.g., activating/inactivating the detection module 18, according to a plurality of controlling signals received by the signal transceiver 12 from the mobile communication terminal 20. The controlling signals may include, for example, an activate control signal and an inactivate control signal for the detection module 18.

The detection module 18 is configured for detecting movements of the headphone 10 to produce a plurality of detection signals accordingly. The detection module 18 is a capacitance acceleration transducer in this embodiment, and the detection signals include a plurality of voltages. Therefore, when the headphone 10 is moved, output voltages of the detection module 18 are varied accordingly.

The mobile communication terminal 20 includes a transceiver module 22, a determination module 24, and a communication module 26.

The transceiver module 22 is configured for communicating with the signal transceiver 12 wirelessly. The output voltages of the detection module 18 are transmitted by the signal transceiver 12 to the transceiver module 22. The transceiver module 22 may be a BLUETOOTH device.

The determination module 24 is configured for storing a first predetermined voltage range and a second predetermined voltage range, and comparing the output voltages received by the transceiver module 22 with the first and the second predetermined voltage ranges to control the communication module 26 accordingly. If the output voltages are in the first predetermined voltage range, the determination module 24 controls the communication module 26 to answer an incoming call to the mobile communication terminal 20. If the output voltages are in the second predetermined voltage range, the determination module 24 controls the communication module 26 to reject the incoming call or terminate an active communication.

The communication module 26 is configured for producing the activate control signal when the mobile communication terminal 20 is receiving an incoming call, and producing the inactivate control signal to the headphone 10 to reject an incoming call or terminate an active communication according to the determination module 24.

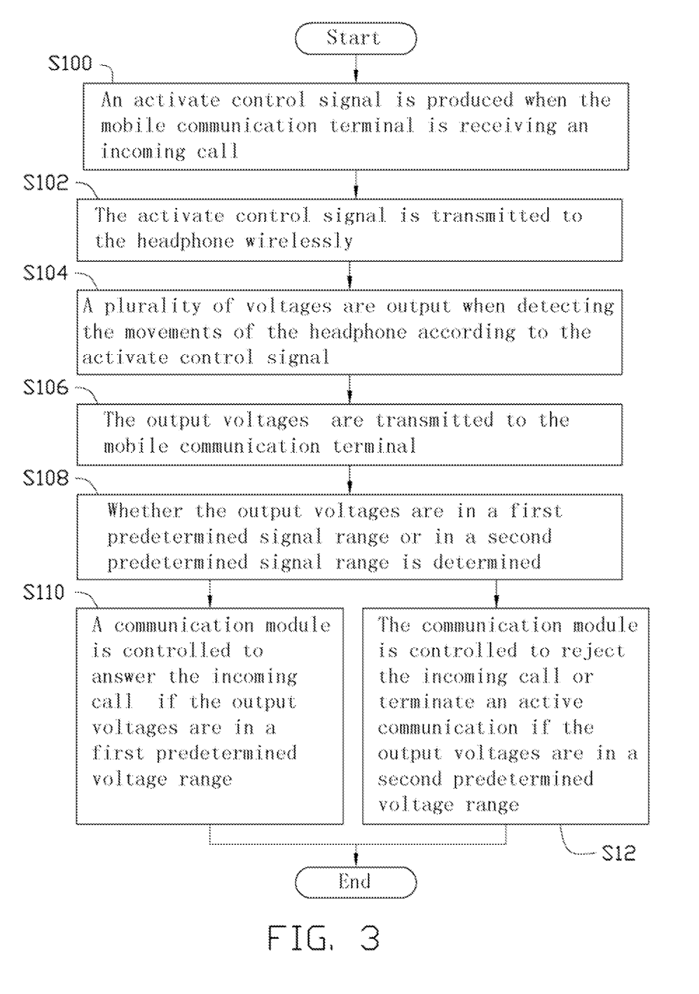

Referring to FIGS. 2 and 3, a controlling method can be implemented by, for example, the mobile communication system 100 and includes the following steps.

In step S100, an activate control signal is produced when the mobile communication terminal 20 is receiving an incoming call. In step S102, the activate control signal is transmitted to the headphone 10 wirelessly. In detail, the activate control signal is transmitted to the headphone 10 via the transceiver module 22 wirelessly. In step S104, a plurality of voltages are output when detecting the movements of the headphone 10 according to the activate control signal. In step S106, the output voltages are transmitted to the mobile communication terminal 20. In step S108, whether the output voltages are in a first predetermined voltage range or in a second predetermined voltage range is determined. If the output voltages are in a first predetermined voltage range, step S110 is implemented, in which the communication module 26 is controlled to answer the incoming call. If the output voltages are in a second predetermined voltage range, step S112 is implemented, in which the communication module 26 is controlled to reject the incoming call or terminate an active communication.

The mobile communication terminal 20 can answer/reject an incoming call or terminate an active communication by remote-control according to the movements of the headphone 10, avoiding an inconvenience of using hands. This is convenient.

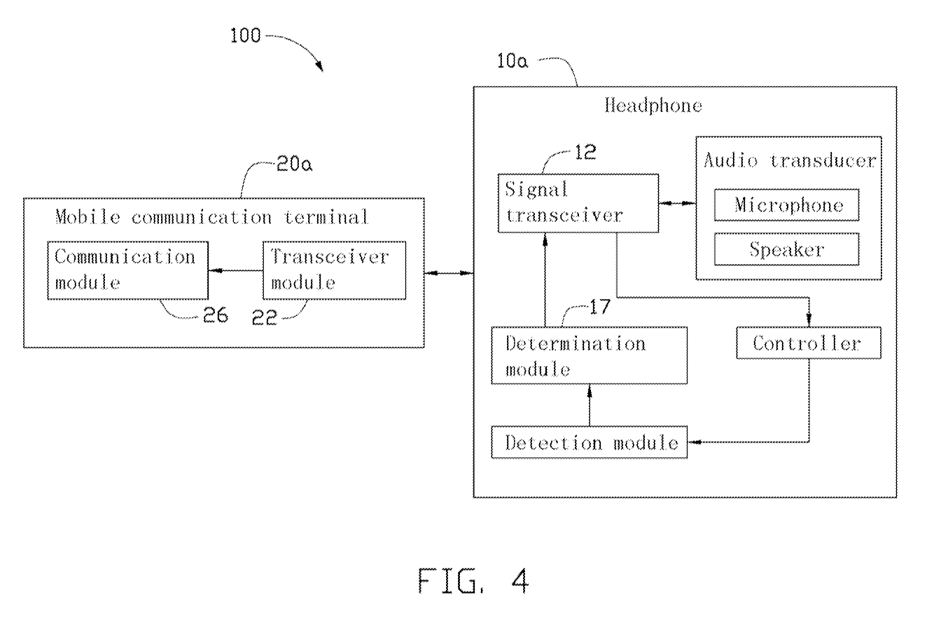

Referring to FIG. 4 together with FIG. 2, a mobile communication system 200, according to a second embodiment is shown. The difference between the mobile communication system 200 of this embodiment and the mobile communication system 100 of the first embodiment is that the determination module 17 is positioned in the headphone 10a instead of being positioned in the mobile communication terminal 20a. If the output voltages are in a first predetermined voltage range, the determination module 17 controls the communication module 26 to answer an incoming call to the mobile communication terminal 20a through the signal transceiver 12 and the transceiver module 22. If the output voltages are in a second predetermined voltage range, the determination module 17 controls the communication module 26 to reject the incoming call or terminate an active communication through the signal transceiver 12 and the transceiver module 22.

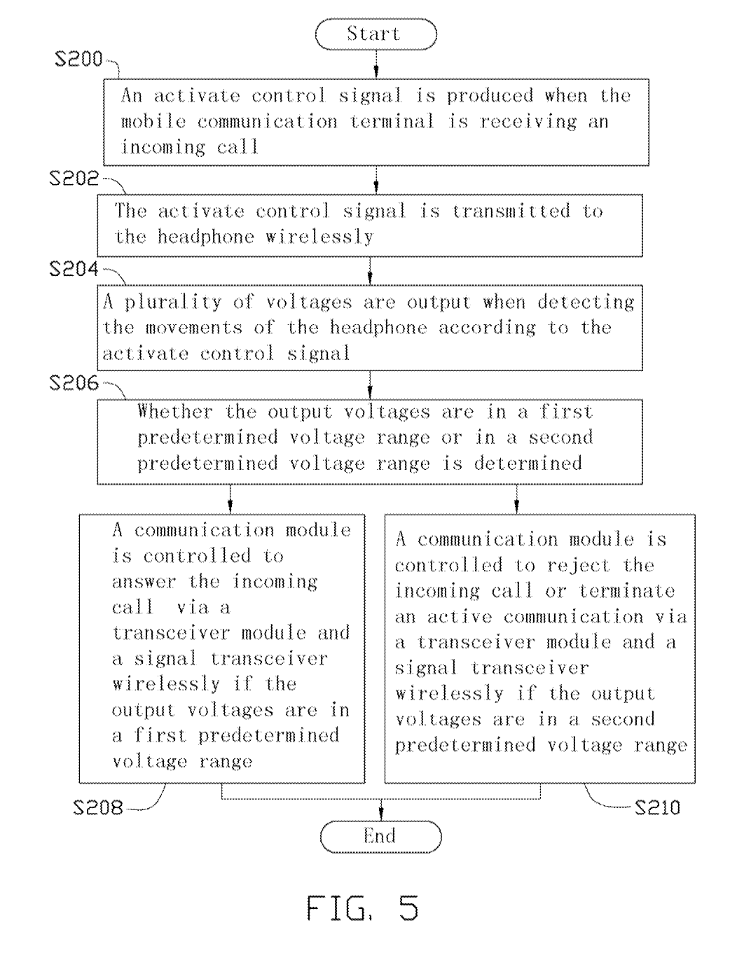

Referring to FIGS. 4 and 5, a controlling method can be implemented by, for example, the mobile communication system 200 and includes the following steps.

In step S200, an activate control signal is produced when the mobile communication terminal 20a is receiving an incoming call. In step S202, the activate control signal is transmitted to the headphone 10a wirelessly. In detail, the activate control signal is transmitted to the headphone 10a via the transceiver module 22 wirelessly. In step S204, a plurality of voltages are output when detecting the movements of the headphone 10a according to the activate control signal. In step S206, whether the output voltages are in a first predetermined voltage range or in a second predetermined voltage range is determined. If the output voltages are in a first predetermined voltage range, step S208 is implemented, in which the communication module 26 is controlled to answer the incoming call via a transceiver module and a signal transceiver wirelessly. If the output voltages are in a second predetermined voltage range, step S210 is implemented, in which the communication module 26 is controlled to reject the incoming call or terminate an active communication via a transceiver module and a signal transceiver wirelessly.

Advantages of the second embodiments are similar to those of the first embodiment.

It is to be understood, however, that even though numerous characteristics and advantages of the present embodiments have been set fourth in the foregoing description, together with details of the structures and functions of the embodiments, the disclosure is illustrative only, and changes may be made in details, especially in matters of shape, size, and arrangement of parts within the principles of the invention to the full extent indicated by the broad general meaning of the terms in which the appended claims are expressed.

What is claimed is:

1. A mobile communication system comprising a headphone and a mobile communication terminal, the headphone comprising:
a signal transceiver configured for communicating with the mobile communication terminal;
an audio transducer electrically connected to the signal transceiver and comprising a microphone and a speaker; and
a detection module configured for detecting movements of the headphone to produce a plurality of detection signals accordingly;
the mobile communication terminal comprising:
a transceiver module configured for communicating with the signal transceiver; and
a communication module configured for answering/rejecting an incoming call or terminating an active communication according to the detection signals.

2. The mobile communication system as claimed in claim 1, wherein the headphone further comprises a controller, and the controller is configured for controlling the detection module according to control signals transmitted from the mobile communication terminal by the signal transceiver.

3. The mobile communication system as claimed in claim 1, wherein the detection module is a capacitance acceleration transducer.

4. The mobile communication system as claimed in claim 1, wherein the detection signals are a plurality of voltages output to the mobile communication terminal.

5. The mobile communication system as claimed in claim 4, wherein the mobile communication terminal further comprises a determination module, and the determination module is configured for storing a first predetermined voltage range and a second predetermined voltage range and comparing the output voltages with the first and the second predetermined voltage ranges to control the communication module accordingly.

6. The mobile communication system as claimed in claim 5, wherein the communication module is controlled to answer an incoming call to the mobile communication terminal by the determination module if the output voltages are in the first predetermined voltage range.

7. The mobile communication system as claimed in claim 5, wherein the communication module is controlled to reject an incoming call or terminate an active communication by the determination module if the output voltages are in the second predetermined voltage range.

8. The mobile communication system as claimed in claim 4, wherein the headphone further comprises a determination module, and the determination module is configured for storing a first predetermined voltage range and a second predetermined voltage range and comparing the output voltages with the first and the second predetermined voltage ranges to control the communication module accordingly.

9. A mobile communication controlling method for a mobile communication system, the method comprising:
producing an activate control signal when a mobile communication terminal is receiving an incoming call;
transmitting the activate control signal to a headphone wirelessly;
outputting a plurality of voltages when detecting the movements of the headphone according to the activate control signal;
transmitting the output voltages to the mobile communication terminal;
determining whether the output voltages are in a first predetermined voltage range or in a second predetermined voltage range.

10. The mobile communication controlling method as claimed in claim 9, further comprising controlling a communication module to answer the incoming call if the output voltages are in the first predetermined voltage range.

11. The mobile communication controlling method as claimed in claim 9, further comprising controlling the communication module to reject the incoming call or terminate an active communication if the output voltages are in the second predetermined voltage range.
